(19) United States
(12) Patent Application Publication
(10) Pub. No.: US 2017/0110913 A1
(43) Pub. Date: Apr. 20, 2017

(54) WIRELESS POWER-TRANSMITTING APPARATUS AND METHOD OF CONTROLLING THE SAME

(71) Applicant: SAMSUNG ELECTRO-MECHANICS CO., LTD., Suwon-si (KR)

(72) Inventors: Eun Young SHIN, Suwon-si (KR); Seung Won PARK, Suwon-si (KR); Sang Ho CHO, Suwon-si (KR); Jae Hyoung CHO, Suwon-si (KR); Jae Suk SUNG, Suwon-si (KR); Chang Ik KIM, Suwon-si (KR)

(73) Assignee: SAMSUNG ELECTRO-MECHANICS CO., LTD., Suwon-si (KR)

(21) Appl. No.: 15/179,272

(22) Filed: Jun. 10, 2016

(30) Foreign Application Priority Data
Oct. 15, 2015 (KR) 10-2015-0144271

(51) Int. Cl. H02J 50/12; H02J 7/02; H02J 50/80

(52) U.S. Cl. CPC H02J 50/12; H02J 50/80; H02J 7/025

(57) ABSTRACT

A wireless power-transmitting apparatus, includes a variable resonator; a power transmitter configured to wirelessly transmit power to a wireless power-receiving apparatus using the variable resonator; and a controller configured to determine class information of the wireless power-receiving apparatus and, in response, control the power transmitter to change impedance of the variable resonator according to the class information.

### CROSS-REFERENCE TO RELATED APPLICATIONS

This application claims the benefit of Korean Patent Application No. 10-2015-0144271, filed on Oct. 15, 2015 in the Korean Intellectual Property Office, the entire disclosure of which is incorporated herein by reference for all purposes.

### BACKGROUND

1. Field

The following description relates to a wireless power-transmitting apparatus and a method of controlling the same.

2. Description of Related Art

Recently, technology for wirelessly charging an electronic apparatus even in a non-contact state has been applied in various fields.

Thus, as the wireless power charging technology has been applied in various fields, various settings in accordance with characteristics of a wireless power-receiving apparatus are required for wireless charging.

However, normally, it is necessary to use a specific type of wireless power-transmitting apparatus specialized for a specific type of wireless power-receiving apparatus.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, a wireless power-transmitting apparatus, includes a variable resonator; a power transmitter configured to wirelessly transmit power to a wireless power-receiving apparatus using the variable resonator; and a controller configured to determine class information of the wireless power-receiving apparatus and, in response, control the power transmitter to change impedance of the variable resonator according to the class information.

The class information may include an indication of at least one of a plurality of classes classified according to at least one of a type, required power, and impedance information of the wireless power-receiving apparatus.

The controller may be further configured to control the power transmitter to transmit a ping signal when a change in impedance of the variable resonator is detected, and to determine the class information from a response signal of the wireless power-receiving apparatus to the ping signal.

The variable resonator may include a variable capacitor; the power transmitter may include an inverter including switches connected to the variable resonator; and a capacitance controller configured to control capacitance of the variable capacitor.

The capacitance controller may be configured to control the capacitance according to a control signal provided by the controller.

The variable capacitor may include capacitors connected in parallel; and switches, each of which may be connected to at least a portion of the capacitors in series.

The class information may be represented by N bits, wherein Nis a natural number greater than 0, and the variable capacitor includes N capacitors connected in parallel.

The controller may provide the class information to the capacitance controller as the control signal.

According to another general aspect, a method of controlling a wireless power-transmitting apparatus includes actuating a wireless power transmitter to transmit a ping signal; receiving a response signal of a wireless power-receiving apparatus to the ping signal, and identifying class information of the wireless power-receiving apparatus from the response signal; and changing impedance of a variable resonator of the wireless power transmitter in response to the identified class information.

The identifying of the class information may include obtaining the class information in a reserved location of a configuration packet included in the response signal.

The class information may correspond to a lower four bits included in a second block of the configuration packet.

The changing of the impedance of the variable resonator may include determining a first impedance corresponding to the identified class information; and changing the capacitance of the variable resonator to be substantially equivalent with the first impedance.

The changing of the impedance of the variable resonator may include determining values of a plurality of bits corresponding to the identified class information; and using the plurality of bits as a control signal for a corresponding plurality of switches included in the variable resonator.

The method may further include wirelessly supplying power by magnetically coupling the variable resonator having the changed impedance with a resonator of the wireless power-receiving apparatus.

According to another general aspect, a wireless power-receiving apparatus, includes: a resonator; a power receiver configured to wirelessly receive a wireless power radiation from a wireless power-transmitter apparatus using the resonator; and a controller configured to communicate a class information of the wireless power-receiving apparatus to the wireless power-transmitter apparatus to control the power transmitter to change an impedance according to the class information.

The controller may be configured to modulate a received wireless power radiation to communicate the class of the wireless power-receiving apparatus to the wireless power-transmitter apparatus.

The wireless power-transmitting apparatus may further include a short-range wireless communication circuit configured to receive an indication of class information of the wireless power-receiving apparatus.

The wireless power-receiving apparatus may further include a short-range wireless communication circuit configured to transmit an indication of class information of the wireless power-receiving apparatus to the wireless power transmitter apparatus.

Other features and aspects will be apparent from the following detailed description, the drawings, and the claims.

### BRIEF DESCRIPTION OF DRAWINGS

FIG. 1 illustrates a wireless power-transmitting apparatus according to an embodiment.

FIG. 2 illustrates a wireless power-transmitting apparatus according to an embodiment.

FIG. 3 is a configuration diagram illustrating a wireless power-transmitting apparatus according to an embodiment.

FIG. 4 illustrates respective phases of wireless power transmission, according to an embodiment.

FIG. 5 is a circuit diagram illustrating an embodiment of a power transmitter illustrated in FIG. 3.

FIG. 6 is a flowchart illustrating a method of controlling a wireless power-transmitting apparatus according to an embodiment.

FIG. 7 is a configuration diagram of a wireless power-receiving apparatus according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower,” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” than the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views. In the drawings, for example, due to manufacturing techniques and/or tolerances, modifications of the shape shown may be encountered. Thus, embodiments should not be construed as being limited to the particular shapes of regions shown herein, but should be understood to include, for example, changes in shape resulting from manufacturing. The following embodiments may also be constituted by one or a combination thereof.

The contents described below may have a variety of configurations.

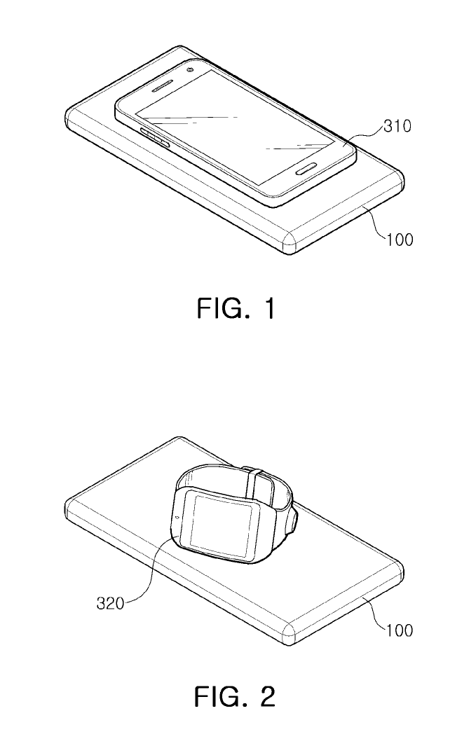

FIG. 1 illustrates an example of a wireless power-transmitting apparatus according to an embodiment, and FIG. 2 illustrates another wireless power-transmitting apparatus according to an embodiment.

In the application example illustrated in FIG. 1, a wireless power-transmitting apparatus 100 charges a mobile terminal 310, and in the application example illustrated in FIG. 2, a wireless power-transmitting apparatus 100 charges a wearable device 320.

Each of the mobile terminal 310 and the wearable device 320 are connected to a wireless power-receiving apparatus. The wireless power-receiving apparatus wirelessly receives power from the wireless power-transmitting apparatus 100 and supplies the power to an internal power reservoir such as a battery, the mobile terminal 310, or the wearable device 320.

The wireless power-receiving apparatus may be applied to various devices in addition to the mobile terminal 310 and the wearable device 320 illustrated in FIGS. 1 and 2.

In this manner, the wireless power-receiving apparatus may be applied to various devices, and the wireless power-transmitting apparatus 100 according to the embodiment changes settings of wireless charging in response to an identification/determination of the wireless power-receiving apparatus applied to such various devices.

For example, the wireless power-transmitting apparatus 100 communicates with the wireless power-receiving apparatus to verify e.g. class, category, power requirements, or capability information of the wireless power-receiving apparatus and responsively control a variable resonator of the wireless power-transmitting apparatus according to the verified class information.

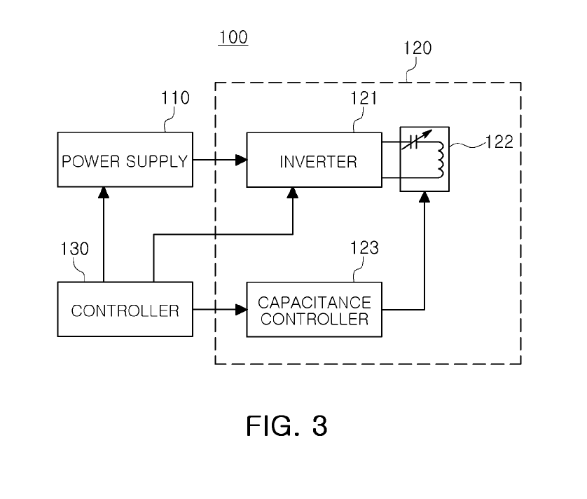

Hereinafter, various embodiments will be described in more detail with reference to FIGS. 3 to 8.

FIG. 3 is a block diagram illustrating a wireless power-transmitting apparatus according to an embodiment.

Referring to FIG. 3, the wireless power-transmitting apparatus 100 includes a power supply 110, a power transmitter 120, and a controller 130.

The power supply 110 generates a predetermined level of power using externally input power. The power supplied by the power supply 110 is supplied to the power transmitter 120.

The power transmitter 120 operates a variable resonator 122 using the power supplied from the power supply 110 and wirelessly transmits the power to the wireless power-receiving apparatus.

The power transmitter 120 includes an inverter 121, the variable resonator 122, and a capacitance controller 123.

The inverter 121 operates in accordance with control of the controller 130, and operates the variable resonator 122 using the power supplied by the power supply 110.

The variable resonator 122 includes, for example, a variable capacitor and an inductor. Since the variable resonator 122 provides variable impedance, it may be magnetically combined with various types of wireless power-receiving apparatuses to wirelessly transmit power therebetween.

The capacitance controller 123 controls capacitance of the variable capacitor included in the variable resonator 122.

The controller 130 controls the power supply 110 and the power transmitter 120.

The controller 130 includes at least one processing unit. In some embodiments, the controller 130 further includes a memory. The processing unit may include, for example, a central processing unit (CPU), a graphics processing unit (GPU), a microprocessor, an application specific integrated circuit (ASIC), a field programmable gate arrays (FPGA), or the like, and may have a plurality of cores. The memory may include a volatile memory (e.g. RAM), a non-volatile memory (e.g. ROM, Flash memory), or a combination thereof.

The controller 130 controls the power transmitter 120 to transmit a ping signal when detecting a change in impedance of the variable resonator 122. When receiving a response signal of the wireless power-receiving apparatus to the ping signal, the controller 130 verifies class information from the response signal.

The controller 130 controls the power transmitter 120 to adjust the impedance of the variable resonator 122 in accordance with the verified class information.

The class information includes a plurality of classes which are classified according to at least one of a type, required/requested power, and impedance information of the wireless power-receiving apparatus.

In some embodiments, the controller 130 has impedance setting data in which predetermined impedance information is set according to respective classes. Accordingly, when the controller 130 verifies the class of the wireless power-receiving apparatus from the class information, the controller 130 identifies or determines an impedance value corresponding to the verified class from the impedance setting data and then controls the variable resonator 122 to have the verified impedance value.

In some embodiments, the class information is represented by N bits (herein, N is a natural, integer number greater than 0), and the variable capacitor included in the variable resonator 122 also includes N capacitors connected in parallel. In this case, the class information is used as a control signal controlling the N capacitors connected in parallel. However, other suitable configurations may be employed, as would be known to one of skill in the art, after gaining a thorough understanding of the following description.

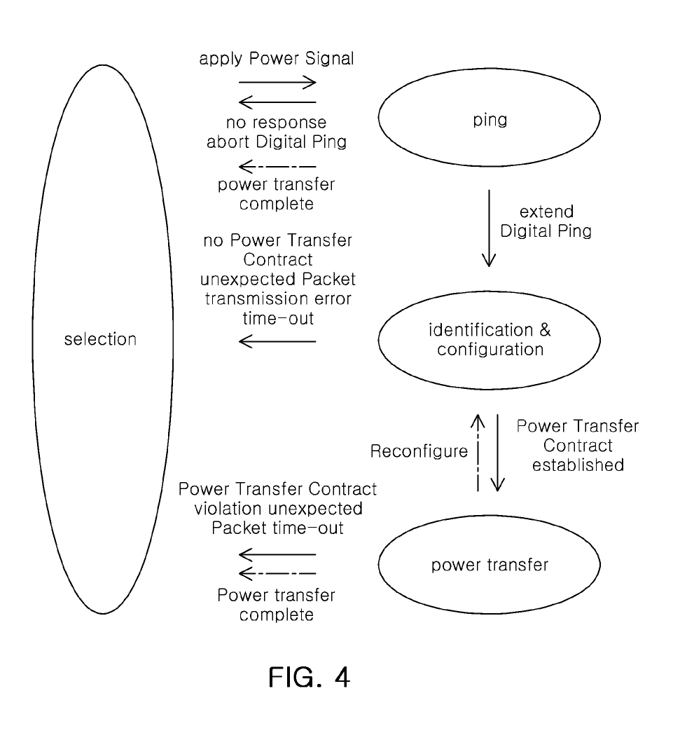

FIG. 4 illustrates respective phases of wireless power transmission.

Referring to FIG. 4, the wireless power transmission includes an initial selection phase.

The selection phase refers to a process step of transmitting, for example, an analog ping signal through a variable resonator, determining a change, such as a change in impedance, caused by the analog ping signal, and determining whether a specific object exists near the wireless power-transmitting apparatus.

In the specification, the analog ping signal collectively refers to a signal for determining an approach of an external object, and there is no limitation on how to express the signal. For example, a signal represented by another expression according to a standard or an embodiment, such as a beacon signal, may correspond to the analog ping signal as long as it determines whether a specific object exists near the wireless power-transmitting apparatus or not.

When a predetermined object is determined as being adjacent to the wireless power-transmitting apparatus in the selection phase, the wireless power-transmitting apparatus transmits a ping signal to check whether the object is a wireless power-receiving apparatus. This is referred to as a ping phase.

When the wireless power-transmitting apparatus receives a response signal of the wireless power-receiving apparatus to the ping signal, it verifies the object to be wirelessly charged and power requirements thereof from the response signal. This is referred to as an identification and configuration phase.

Next, the variable resonator is controlled, that is, the impedance of the variable resonator is changed according to the verified information, to wirelessly transmit power according to the changed impedance. This is referred to as a power transfer phase.

In each of the above-described phases, the signals are classified into predetermined packets or wavetrains, and Table 1 illustrates examples of types and sizes of the packets used in respective phases.

TABLE 1

| | | |
|---|---|---|
| Header | Packet Types | Message Size |

Ping Phase

| | | |
|---|---|---|
| 0x01 | Signal Strength | 1 |
| 0x02 | End Power Transfer | 1 |

Identification & Configuration Phase

| | | |
|---|---|---|
| 0x06 | Power Control Hold-off | 1 |
| 0x51 | Configuration | 5 |
| 0x71 | Identification | 7 |
| 0x81 | Extended Identification | 8 |

Power transfer Phase

| | | |
|---|---|---|
| 0x02 | End Power Transfer | 1 |
| 0X03 | Control Error | 1 |
| 0x04 | Received Power | 1 |
| 0x05 | Charge Status | 1 |

In some embodiments, the wireless power-transmitting apparatus verifies information of the wireless power-receiving apparatus from the response signal to the ping signal, that is, from the ping phase and the identification and configuration phase.

Table 2 to Table 5 illustrate packets of the identification and configuration phase, and each of the packets may be a response signal, that is, an example of a packet transferred from the wireless power-transmitting apparatus.

TABLE 2

| | | | | | | | |
|---|---|---|---|---|---|---|---|
| b7 | b6 | b5 | b4 | b3 | b2 | b1 | b0 |

| | |
|---|---|
| B0 | Power Control Hold-off Time |

TABLE 3

| | | | | | | | |
|---|---|---|---|---|---|---|---|
| b7 | b6 | b5 | b4 | b3 | b2 | b1 | b0 |

| | | |
|---|---|---|
| B0 | Power Class | Maximum Power |

| B1 | Reserved | | | |
|---|---|---|---|---|
| B2 | Prop | Reserved | ZERO | Count |

| | | |
|---|---|---|
| B3 | Window Size | Window Offset |

| | |
|---|---|
| B4 | Reserved |

TABLE 4

| | | | | | | | |
|---|---|---|---|---|---|---|---|
| b7 | b6 | b5 | b4 | b3 | b2 | b1 | b0 |

| | | |
|---|---|---|
| B0 | Major Version | Minor Version |

| | | |
|---|---|---|
| B1 | (msb) | Manufacturer Code |

| | |
|---|---|
| B2 | (lsb) |

| | | |
|---|---|---|
| B3 | Ext | (msb) |

| | |
|---|---|
| ? | Basic Device Identifier |

| | |
|---|---|
| B6 | (lsb) |

TABLE 5

| | | | | | | | |
|---|---|---|---|---|---|---|---|
| b7 | b6 | b5 | b4 | b3 | b2 | b1 | b0 |

| | | |
|---|---|---|
| B0 | (msb) | Extended Device Identifier |

| | |
|---|---|
| ? | |
| B7 | (lsb) |

Table 2 illustrates a power control hold-off packet, and Table 3 illustrates a configuration packet. Table 4 illustrates an identification packet, and Table 5 illustrates an extended identification packet.

In an embodiment, according to requirements of the wireless power-receiving apparatus, the wireless power-receiving apparatus may be classified into a plurality of classes. The wireless power-transmitting apparatus verifies the class of the wireless power-receiving apparatus, and changes the variable resonator to have impedance set according to the verified class. Here, the class information of the wireless power-transmitting apparatus is verified by the identification packet illustrated in Table 3.

As illustrated in Table 3, the identification packet includes at least one reserved location. The reserved location may correspond to a location not specified in a wireless communications standard such as the Wireless Power Consortium (WPC).

According to an embodiment, the class information of the wireless power-receiving apparatus is transferred using the reserved location of the identification packet.

TABLE 6

| | | | | | | | |
|---|---|---|---|---|---|---|---|
| b7 | b6 | b5 | b4 | b3 | b2 | b1 | b0 |

| | | |
|---|---|---|
| B0 | Power Class | Maximum Power |

| B1 | Reserved | | Class | |
|---|---|---|---|---|
| B2 | Prop | Reserved | ZERO | Count |

| | | |
|---|---|---|
| B3 | Window Size | Window Offset |

| | |
|---|---|
| B4 | Reserved |

Table 6 illustrates an example in which class information is stored in the lower four bits included in a second block of the configuration packet.

The controller 130 (please refer to FIG. 3) of the wireless power-transmitting apparatus checks the reserved location of the identification packet (the example illustrated in Table 3) or the class information (the example illustrated in Table 6) to verify the class of the wireless power-receiving apparatus. As illustrated in the example of Table 6, the class information may be expressed by N bits (herein, N is a natural number).

In some embodiments, the above-described ping signal or response signal thereto is transmitted and/or received in an in-band communication method. For example, since the wireless power-transmitting apparatus and the wireless power-receiving apparatus are magnetically coupled, data is provided in the in-band communication method by performing a modulation to the signal in the coupled state.

In other embodiments, the above-described ping signal or response signal thereto is transmitted or received between the wireless power-transmitting apparatus and the wireless power-receiving apparatus in a short-range communication method (e.g., Bluetooth, NFC, Zigbee, WiFi).

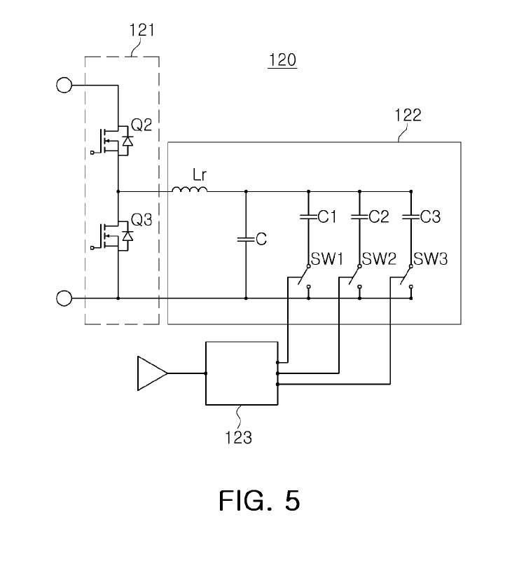

FIG. 5 is a circuit diagram illustrating an embodiment of the power transmitter illustrated in FIG. 3.

Referring to FIG. 5, the power transmitter 120 includes an inverter 121, a variable resonator 122, and a capacitance controller 123.

The inverter 121 includes a plurality of switches. The inverter 121 operates the variable resonator 122 by a switching operation according to the control of the controller 130 (please refer to FIG. 3).

In the embodiment illustrated in FIG. 5, the inverter 121 is a half-bridge inverter in which two switches Q2 and Q3 are connected in series, but is not limited thereto. Accordingly, the inverter 121 may be another type of inverter such as a full-bridge inverter, or other suitable inverter implementation. The inverter 121 is controllable in a fixed frequency method, a variable frequency method, a duty ratio modulation method, a phase shift method, or other suitable scheme, as would be known to one of skill in the art after gaining a thorough understanding of the following description.

The variable resonator 122, according to an embodiment, includes a variable capacitor and an inductor.

In some embodiments, the variable resonator 122 includes a variable capacitor having a ladder structure. For example, as illustrated in FIG. 5, the variable resonator 122 includes a plurality of capacitors C, C1, and C3 connected in parallel and a plurality of switches SW1, SW2, and SW3 respectively connected to at least portions of the plurality of capacitors C, C1, and C3 in series. Resonance impedance of the variable resonator 122 is changed according to the change of capacitance of the variable capacitor.

The capacitance controller 123 controls the capacitance of the variable resonator 122 according to a control signal provided by the controller 130 (please refer to FIG. 3).

In some embodiments, the number of bits of the class information is the same as the number of capacitors connected in parallel in the variable capacitor. In this case, a bit value corresponding to the class information is used as a switching signal of the capacitors connected in parallel in the variable capacitor. For example, in Table 6, the class information includes four bits, and the number of parallel capacitors illustrated in FIG. 5 is four. In this case, three lower bits of the class information are respectively used as a switching control signal of the switches SW1, SW2, and SW3. In an embodiment, the controller controls variable capacitance without an additional calculation process.

In the embodiment illustrated in FIG. 5, the variable resonator 122 changes capacitance to change impedance, but is not limited thereto. Accordingly, the variable resonator 122 according to the embodiment changes inductance to change impedance.

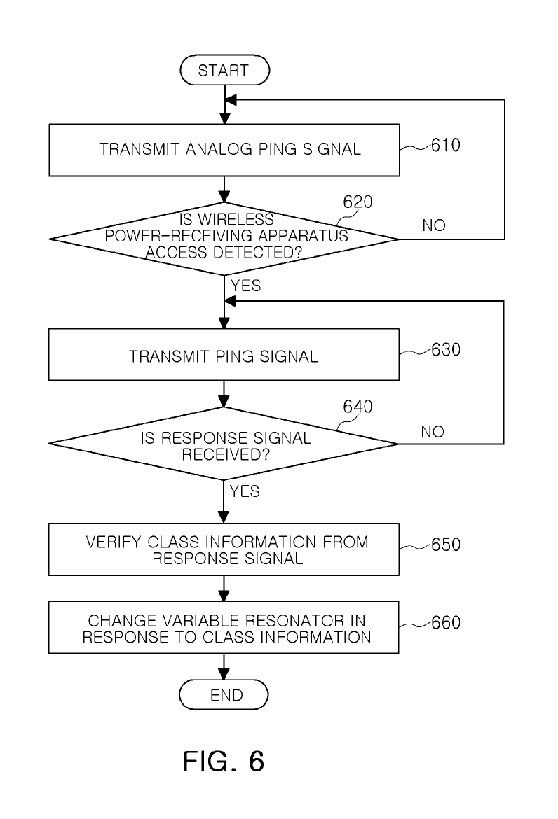

FIG. 6 is a flowchart illustrating a method of controlling a wireless power-transmitting apparatus according to an embodiment. In a selection phase illustrated in FIG. 6, an approach of an object is detected by transmitting an analog ping signal. The method of controlling the wireless power-transmitting apparatus illustrated in FIG. 6 is performed in the wireless power-transmitting apparatus described with reference to FIGS. 3 to 5.

Referring to FIG. 6, the wireless power-transmitting apparatus transmits the analog ping signal (S610).

The wireless power-transmitting apparatus detects the approach of a predetermined device, such as a wireless power-receiving apparatus, when a change (e.g. change in impedance) of the analog ping signal is detected (S620, YES). When the approach of the predetermined device is not detected (S620, NO), the wireless power-transmitting apparatus periodically transmits the analog ping signal (S610).

The wireless power-transmitting apparatus transmits a ping signal (S630).

When a response signal of the wireless power-receiving apparatus to the ping signal is received (S640, YES), the wireless power-transmitting apparatus verifies class information of the wireless power-receiving apparatus from the response signal (S650).

When the response signal of the wireless power-receiving apparatus to the ping signal is not received (S640, NO), the wireless power-transmitting apparatus continues to re-transmit the ping signal (S630).

The wireless power-transmitting apparatus changes the impedance of a variable resonator in response to the class information (S660).

In some embodiments, the class information includes a plurality of classes which are classified according to at least one of the types, required power, and impedance information of the wireless power-receiving apparatus.

Table 7 below illustrates an example of the classes.

TABLE 7

| Class | Division | Comment |
|---|---|---|
| 0000 | Phone | Mobile Phone |
| 0001 | Wearable | Product Family having different impedance |
| | | from Mobile Phone |
| nnnn | Others | Total 16 types are represented with four |
| | | bits. |

In some embodiments of the step S650, the wireless power-transmitting apparatus obtains the class information from the reserved location of the configuration packet included in the response signal.

For example, as illustrated in Table 6, the class information corresponds to the lower four bits included in the second block of the configuration packet.

In some embodiments of the step S660, the wireless power-transmitting apparatus checks a first impedance corresponding to the verified class information, and controls the capacitance of the variable resonator in such a manner that the variable resonator has substantially the first impedance. In one or more embodiments, the impedance value according to class information is stored in or externally input to the wireless power-transmitting apparatus in advance.

In other embodiments of the step S660, the wireless power-transmitting apparatus verifies a plurality of bits corresponding to the verified class information, and uses the plurality of bits as control signals of the plurality of switches included in the variable resonator.

In some embodiments, the method of controlling the wireless power-transmitting apparatus further includes magnetically coupling the variable resonator having the changed impedance with a resonator of the wireless power-receiving apparatus to wirelessly supply power.

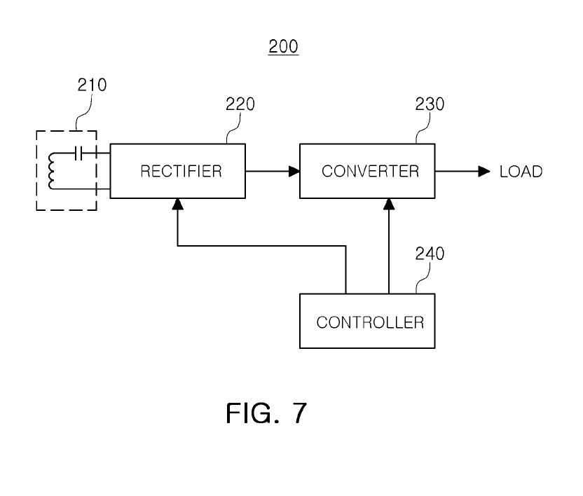

FIG. 7 is a block diagram of a wireless power-receiving apparatus according to an embodiment.

Referring to FIG. 7, a wireless power-receiving apparatus 200 includes a power receiver 210 (including a resonator) and a rectifier 220. In some embodiments, the wireless power-receiving apparatus 200 may further include a converter 230 and/or a controller 240.

The power receiver 210 is magnetically coupled with a power transmitter of a wireless power-transmitting apparatus to wirelessly receive power.

The rectifier 220 rectifies the power received by the power receiver 210.

The converter 230 converts the rectified power to have a level required, requested, or specified by a load.

The controller 240 controls an operation of the rectifier 220 or the converter 230 to wirelessly receive power and/or to convert the received power and supply it to the load.

As set forth above, a wireless power-transmitting apparatus according to an embodiment and a control method thereof have an advantage in which power can be customized and effectively transmitted to various wireless power-receiving apparatuses.

In addition, a wireless power-transmitting apparatus according to an embodiment and a control method thereof have an advantage in which power can be transmitted with high efficiency from the start of the power transmission.

The apparatuses, units, modules, devices, controllers, and other components illustrated in FIGS. 1-3, 5, and 7 that perform the operations described herein with respect to FIGS. 4 and 6 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 4 and 6. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 4 and 6 that perform the operations described herein may be performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art, after gaining a thorough understanding of the present disclosure, can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power-transmitting apparatus, comprising:
a variable resonator;
a power transmitter configured to wirelessly transmit power to a wireless power-receiving apparatus using the variable resonator; and
a controller configured to determine class information of the wireless power-receiving apparatus and, in response, control the power transmitter to change impedance of the variable resonator according to the class information.

2. The wireless power-transmitting apparatus of claim 1, wherein the class information includes an indication of at least one of a plurality of classes classified according to at least one of a type, required power, and impedance information of the wireless power-receiving apparatus.

3. The wireless power-transmitting apparatus of claim 1, wherein the controller is further configured to control the power transmitter to transmit a ping signal when a change in impedance of the variable resonator is detected, and to determine the class information from a response signal of the wireless power-receiving apparatus to the ping signal.

4. The wireless power-transmitting apparatus of claim 3, wherein,
the variable resonator comprises a variable capacitor;
the power transmitter comprises:
an inverter including switches connected to the variable resonator; and
a capacitance controller configured to control capacitance of the variable capacitor.

5. The wireless power-transmitting apparatus of claim 4, wherein the capacitance controller is configured to control the capacitance according to a control signal provided by the controller.

6. The wireless power-transmitting apparatus of claim 4, wherein the variable capacitor comprises:
capacitors connected in parallel; and
switches, each of which is connected to at least a portion of the capacitors in series.

7. The wireless power-transmitting apparatus of claim 4, wherein the class information is represented by N bits, wherein N is a natural number greater than 0, and
the variable capacitor includes N capacitors connected in parallel.

8. The wireless power-transmitting apparatus of claim 7, wherein the controller provides the class information to the capacitance controller as the control signal.

9. A method of controlling a wireless power-transmitting apparatus, the method comprising:
actuating a wireless power transmitter to transmit a ping signal;
receiving a response signal of a wireless power-receiving apparatus to the ping signal, and identifying class information of the wireless power-receiving apparatus from the response signal; and
changing impedance of a variable resonator of the wireless power transmitter in response to the identified class information.

10. The method of claim 9, wherein the class information comprises an indication of at least one of a plurality of classes classified according to at least one of a type, required power, and impedance information of the wireless power-receiving apparatus.

11. The method of claim 9, wherein the identifying of the class information comprises obtaining the class information in a reserved location of a configuration packet included in the response signal.

12. The method of claim 11, wherein the class information corresponds to a lower four bits included in a second block of the configuration packet.

13. The method of claim 9, wherein the changing of the impedance of the variable resonator comprises:
determining a first impedance corresponding to the identified class information; and
changing the capacitance of the variable resonator to be substantially equivalent with the first impedance.

14. The method of claim 9, wherein the changing of the impedance of the variable resonator comprises:
determining values of a plurality of bits corresponding to the identified class information; and
using the plurality of bits as a control signal for a corresponding plurality of switches included in the variable resonator.

15. The method of claim 9, further comprising wirelessly supplying power by magnetically coupling the variable resonator having the changed impedance with a resonator of the wireless power-receiving apparatus.

16. A wireless power-receiving apparatus, comprising:
a resonator;
a power receiver configured to wirelessly receive a wireless power radiation from a wireless power-transmitter apparatus using the resonator; and
a controller configured to communicate a class information of the wireless power-receiving apparatus to the wireless power-transmitter apparatus to control the power transmitter to change an impedance according to the class information.

17. The wireless power-receiving apparatus of claim 16, wherein the controller is configured to modulate a received wireless power radiation to communicate the class of the wireless power-receiving apparatus to the wireless power-transmitter apparatus.

18. The wireless power-transmitting apparatus of claim 1, further comprising:
a short-range wireless communication circuit configured to receive an indication of class information of the wireless power-receiving apparatus.

19. The wireless power-receiving apparatus of claim 16, further comprising:
a short-range wireless communication circuit configured to transmit an indication of class information of the wireless power-receiving apparatus to the wireless power transmitter apparatus.
